(19) United States
(12) Patent Application Publication
(10) Pub. No.: US 2025/0292380 A1
(43) Pub. Date: Sep. 18, 2025

(54) HARDWARE-IMPLEMENTED CNN FOR VIDEO SCORING

(71) Applicant: GOOGLE LLC, Mountain View, CA (US)

(72) Inventors: Daniele Moro, Sunnyvale, CA (US); Pratik Marolia, Mountian View, CA (US); Hossein Talebi, San Jose, CA (US)

(21) Appl. No.: 18/608,427

(22) Filed: Mar. 18, 2024

(51) Int. Cl. G06T 7/00; G06N 3/0464; H04N 19/154

(52) U.S. Cl. CPC G06T 7/0002; G06N 3/0464; H04N 19/154; G06T 2207/10016

(57) ABSTRACT

A sequence of convolutional operations of a quantized convolutional neural network (quantized CNN) is performed on an input video frame using quantized weights to generate feature maps. Respective batch normalizations are applied to the feature maps to obtain normalized feature maps. Applying a batch normalization to a feature map of the feature maps includes applying a linear function to the feature map where the linear function includes multiplying each feature of the feature map by a learned scaling factor. After applying the respective batch normalizations, the normalized feature maps are processed through additional layers of the quantized CNN to determine a probability that the input video frame is of low quality.

### BACKGROUND

Convolutional Neural Networks (CNNs) have found widespread application across a variety of image processing tasks, demonstrating their versatility and effectiveness in extracting hierarchical features from visual data. A notable challenge with CNNs arises from the extensive number of parameters and the computational intensity of floating-point operations, which can significantly impact the overall performance and efficiency of the network during both the training and inference phases.

### SUMMARY

A first aspect is a method that includes performing a sequence of convolutional operations of a quantized convolutional neural network (quantized CNN) on an input video frame using quantized weights to generate feature maps; and applying respective batch normalizations to the feature maps to obtain normalized feature maps. Applying a batch normalization to a feature map of the feature maps includes applying a linear function to the feature map where the linear function includes multiplying each feature of the feature map by a learned scaling factor. The method also includes, after applying the respective batch normalizations, processing the normalized feature maps through additional layers of the quantized CNN to determine a probability that the input video frame is of low quality.

A second aspect is a device that includes a quantized convolutional neural network (quantized CNN) that is configured to perform a sequence of convolutional operations on an input video frame using quantized weights to generate feature maps; and apply respective batch normalizations to the feature maps to obtain normalized feature maps. To apply a batch normalization to a feature map of the feature maps includes to apply a linear function to the feature map, where the linear function includes multiplying each feature of the feature map by a learned scaling factor. The quantized CNN is also configured to, after applying the respective batch normalizations, process the normalized feature maps through additional layers of the quantized CNN to determine a probability that the input video frame is of low quality.

A third aspect is a device that includes a quantized convolutional neural network (quantized CNN). The quantized CNN includes a first convolutional layer; a second convolutional layer subsequent to and coupled to the first convolutional layer; a third convolutional layer subsequent to and coupled to the second convolutional layer; a fourth max pooling layer subsequent to and coupled to the third convolutional layer; a fifth convolutional layer subsequent to and coupled to the fourth max pooling layer; a sixth global average pooling layer subsequent to and coupled to the fifth convolutional layer; and a seventh dense layer subsequent to and coupled to the sixth global average pooling layer. The seventh dense layer simulates a sigmoid function by comparing an output of a fully connected layer to a constant learned during a training phase. At least one of the first convolutional layer, the second convolutional layer, the third convolutional layer, or the fifth convolutional layer is configured to apply a batch normalization to an input feature map by applying a linear function to the input feature map, where the linear function includes multiplying each feature of the input feature map by a learned scaling factor. None of the layers are configured to perform floating point operations. Weights of the quantized CNN are fixed point weights learned during a training process that uses simulated and heterogeneous quantization.

These and other aspects of the present disclosure are disclosed in the following detailed description of the embodiments, the appended claims and the accompanying figures.

### BRIEF DESCRIPTION OF THE DRAWINGS

The description herein makes reference to the accompanying drawings described below, wherein like reference numerals refer to like parts throughout the several views.

FIG. 1 depicts a high-level block diagram of a video processing system 100 that utilizes a quantized Convolutional Neural Network (CNN) for video quality assessment and transcoding.

FIG. 2 is a block diagram of an example of a computing device.

FIG. 3 is a block diagram of a high level process of obtaining a quantized CNN.

FIG. 4 illustrates an architecture of a software-implemented quantized CNN.

FIG. 5 is a block diagram of a structure of a quantized convolutional layer as implemented in hardware.

FIG. 6 illustrates quantization aware training of the SIQ CNN of FIG. 4.

FIG. 7A is a block diagram of an encoder.

FIG. 7B is a diagram of an example of a video stream to be encoded and subsequently decoded.

FIG. 8 is a block diagram of a decoder.

FIG. 9 is a flowchart of a technique for determining the probability of a video frame being of low quality.

### DETAILED DESCRIPTION

The ever-increasing demand for video content across various platforms necessitates efficient video transcoding techniques to ensure optimal quality and bandwidth usage. It is estimated that 500 hours of video are uploaded to a certain video sharing site per minute and that the site accounts for 15% of daily global internet traffic. Transcoding videos is essential for adapting them to different devices, resolutions, and network conditions. The quality (e.g., aesthetic or subjective qualities) of a video can be used to derive (e.g., configure or set) transcoding parameters. However, manually determining the best transcoding parameters for each video can be at best cumbersome if not practically impossible given the growth in video content and the diverse range of devices and network conditions that must be taken into consideration in the transcoding process. Automatic generation of transcoding parameters becomes critical, leveraging advanced algorithms to assess video quality and determine the most efficient encoding settings.

Convolutional Neural Networks (CNNs) have been used for assessing video quality, offering a way to score videos on a scale that closely correlates with human perception (e.g., human subjective judgment). By analyzing frames or segments of a video, these models can predict quality scores that inform the transcoding process. That is, transcoding parameters can be derived from these scores, enabling automated optimization of video quality and compression such that videos are transcoded with parameters that maintain quality while minimizing bandwidth and storage requirements. Selecting transcoding parameters based on the quality score of a video is premised on the observation that human viewers are less sensitive to compression distortions on low quality videos than on high quality ones.

While software models like CNNs are effective in scoring videos, they are not without their drawbacks. These models typically require significant computational resources and processing time, which can introduce latency in video processing pipelines. These factors can limit the practicality and efficiency of relying solely on software models for video transcoding in real-time or high-demand scenarios. One solution to these problems is to implement such CNN models in hardware.

Directly implementing CNN software models in hardware poses several challenges. Hardware models must satisfy stringent constraints regarding power consumption, processing speed, physical on-chip area, and the number of logic gates. These constraints necessitate optimizations that can compromise the model's accuracy or complexity. Additionally, CNNs execute a variety of complex mathematical operations, central among them being convolutional operations, activation functions, and batch normalization. Each of these operations presents unique challenges when attempting to implement them directly onto hardware.

Convolutional operations are the core of CNNs, involving the calculation of dot products between weights (which are typically high-precision floating point numbers) of filters and local regions of the input data. Convolutional operations are computationally intensive due to the high volume of multiplications and additions, especially for high-resolution inputs or deep networks with many layers. Common activation functions like Rectified Linear Unit (ReLU) or sigmoid are used to introduce non-linearities into the network, allowing it to learn complex patterns. While conceptually simple, implementing these functions in hardware requires precise and efficient computation to handle the non-linear transformations accurately. The batch normalization operation normalizes the inputs to a layer for each mini-batch, stabilizing the learning process. It involves calculations of the mean and variance of the batch, followed by scaling and shifting operations. Batch normalization involves division and square root operations, which are particularly challenging for hardware due to their complexity and the precision required.

Such operations are not considered hardware-friendly for several reasons. The sheer volume of calculations required for processing even a single frame of video in real-time can overwhelm hardware resources. Many CNN operations require floating-point precision to maintain accuracy, which is resource-intensive in terms of both computation and storage on hardware. Being “not hardware-friendly” means that direct implementation of these operations into hardware can lead to inefficiencies, such as increased power consumption, larger physical area requirements, prohibitively larger number of logic gates, and slower processing speeds.

Floating-point arithmetic (e.g., addition, subtraction, multiplication, and/or division) is inherently complex and requires handling significands (mantissas), exponents, and signs separately, along with the rules for normalization, rounding, and handling special cases like zeros, infinities, and NaN (Not a Number). This complexity demands more logic gates, which increases the silicon area required and, consequently, the power consumption. Floating-point operations typically take long to execute because of their complexity. This increased latency can be a bottleneck for real-time processing tasks where timely response may be critical. The increased complexity and larger area requirements for floating-point arithmetic translate directly into higher costs.

A hardware-implemented CNN for video scoring that is according to implementations of this disclosure solves the foregoing problems. The described design of the CNN overcomes those challenges via specialized optimizations, such as quantization (e.g., reducing the precision of the calculations). The model is designed to avoid float-point operations, replacing them with simpler integer operations and heavily relying on binary shift operations. The model's architecture is optimized for efficiency, employing quantization techniques to reduce model size and computational complexity, enabling the model to run on custom hardware with minimal resource usage.

The described model operates with a small footprint in terms of both power consumption and chip area. Additionally, the model incorporates hardware-friendly operations, such as replacing certain mathematical operations with simpler equivalents that are easier to compute in hardware. A non-conventional loss function (e.g., referred to herein as the negative squared Pearson linear correlation coefficient) is used in the training the model. Additionally, with respect to sigmoid activations, the model is designed to avoid division and exponentiation operations and to reducing activation to a mere comparison to a threshold value. Other non-conventional design and optimization techniques are further described herein.

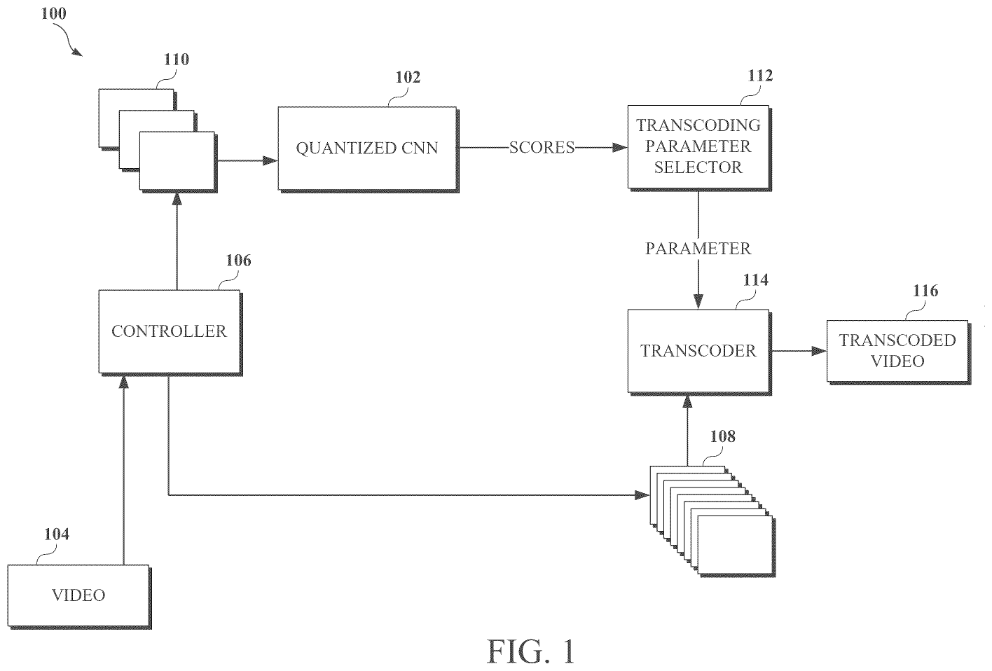

FIG. 1 depicts a high-level block diagram of a video processing system 100 that utilizes a quantized Convolutional Neural Network (CNN) for video quality assessment and transcoding.

A quantized CNN 102 determines the visual quality of a video where the determined quality highly correlates with human subjective judgment. The quantized CNN 102 is implemented using custom hardware. That is, the quantized CNN 102 is specifically ‘Siliconized’—engineered into a silicon-based integrated circuit optimized for the computational demands and precision requirements of the network's quantization parameters, facilitating real-time analysis and assessment of video quality in line with subjective human standards.

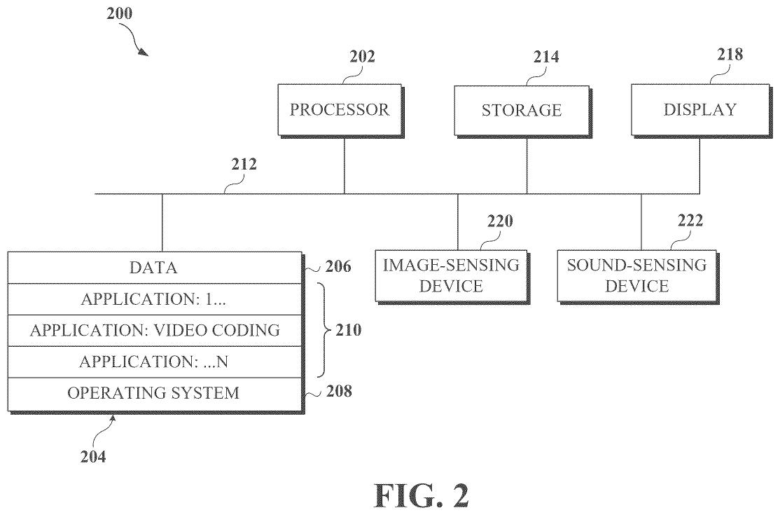

The quantized CNN 102 has been shown capable of 1027 inferences per second, is implemented with roughly 305,000 total logic gates, requires less than 51,500 bytes of Static Random Access Memory (SRAM) of on-chip memory dedicated to storing intermediate data (such as feature maps and weights) during the processing of input data through the layers of the quantized CNN 102, and can be fabricated on a die that occupies roughly 0.051 mm² of area, utilizing a 5 nanometer (nm) process technology. The quantized CNN 102 does not perform floating point operations. The quantized CNN 102 can be implemented or included in a computing device, such as the computing device 200 of FIG. 2.

A controller 106 of the video processing system 100 receives a video 104 as input. The controller 106 can be implemented by the computing device as executable instructions that may be stored in a memory, such as the memory 204 of FIG. 2, and that, when executed by a processor, such as the processor 202 of FIG. 2, cause the processor to perform the actions described herein with respect to the controller 106.

The video 104 is a sequence of frames that comprise the video content to be processed. The controller 106 may divide the video 104 into segments, such as a segment 108. Each segment may include a certain number of frames or, equivalently, may correspond to a certain amount of time. To illustrate, assuming that the video 104 is captured at a 24/30/60 frames per second and assuming that the segment 108 has a length of 5 seconds, then segment 108 would include 120/150/300 frames, respectively. As further described herein, each segment of the video 104 may be transcoded using different transcoding parameters.

A subset 110 of the frames of the segment 108 are input, such as one at a time, to the quantized CNN 102. The controller 106 may select the frames of the subset 110 in any number of ways. To illustrate, and without limitations, the subset 110 may include randomly selected N (e.g., 5, 10, 20) frames or the subset may include every M^{th} frame of the segment 108.

In some implementations, the subset 110 of the frames includes only the luminance planes of the frames instead of all of the luminance Y, chrominance U, and chrominance V planes of the frames. This simplification is based on the premise that luminance carries significant perceptual information pertinent to human visual quality assessment. Implementations that utilize all color planes are feasible; however, to streamline the model's complexity and computational load, training the quantized CNN 102 to focus on the luminance plane alone has proven efficacious. Empirical evidence indicates that by inputting only the luminance data, there is a notable reduction in the number of parameters—by approximately 2.5%—and a substantial decrease in the volume of input data, by as much as 66%, thereby enhancing the operational efficiency of the quantized CNN 102 without substantially sacrificing performance in visual quality determination.

As further described herein, the “quantized” aspect (in “quantized CNN”) refers to the network operating with reduced precision arithmetic, such as 8-bit or 16-bit fixed-point numbers, instead of, for example, 32-bit floating-point numbers. This allows for more efficient computation, particularly on specialized hardware designed for fast and low-power operation. The quantized CNN processes the video frames of the subset 110 to predict visual quality scores for segment 108.

The quantized CNN 102 is trained to evaluate the visual quality of video frames of the subset 110. More specifically, the quantized CNN 102 may be trained to output a value relating to a probability that a frame is of low quality. The quantized CNN 102 may be trained to output the probability value itself. The quantized CNN 102 may be trained to output whether the probability that the frame is of low-quality. For example, if the probability that the frame is of low quality (is not of low quality), the quantized CNN 102 may be trained to output a 0 (to output a 1). If the probability output for a frame is low, then the frame is assumed to be of good quality. Conversely, if the probability output for a frame is high, then the frame is assumed to be of low quality. Stated yet another way, if the probability is low, then the frame is assumed to have good quality. The output of the quantized CNN 102 is further described below. The visual quality of the subset 110 is assumed to be representative of the visual quality of the segment 108.

The quantized CNN 102 may sequentially process the frames of the subset 110. That is, the frames of the subset 110 may be streamed into the quantized CNN 102. While the quantized CNN 102 may process one frame at a time, there could be multiple frames within the quantized CNN 102 at different stages of the quantized CNN 102.

A transcoding parameter selector 112 receives and averages the scores of the frames of the subset 110. The transcoding parameter selector 112 can be or can be implemented by the controller 106. The average score is assumed to be representative of the quality of the segment 108. Based on the visual quality scores produced by the quantized CNN 102, the transcoding parameter selector 112 determines the optimal transcoding parameters for the segment 108. Examples of parameters might include bitrate, resolution, frame rate, and codec settings. For instance, if the average of the scores obtained from the quantized CNN 102 predicts high visual quality, the transcoding parameter selector 112 may choose a higher bitrate to preserve quality. If the average score indicates low quality (e.g., high probability of a low quality), then parameters that result in a lower bitrate may be selected to save bandwidth since the quality is already compromised. That is, if the average probability is low, then the selected transcoding parameters do not result in aggressively transcoding; and if the average probability is high, then the selected transcoding parameters result in aggressive transcoding of the segment 108. Aggressive transcoding means higher compression.

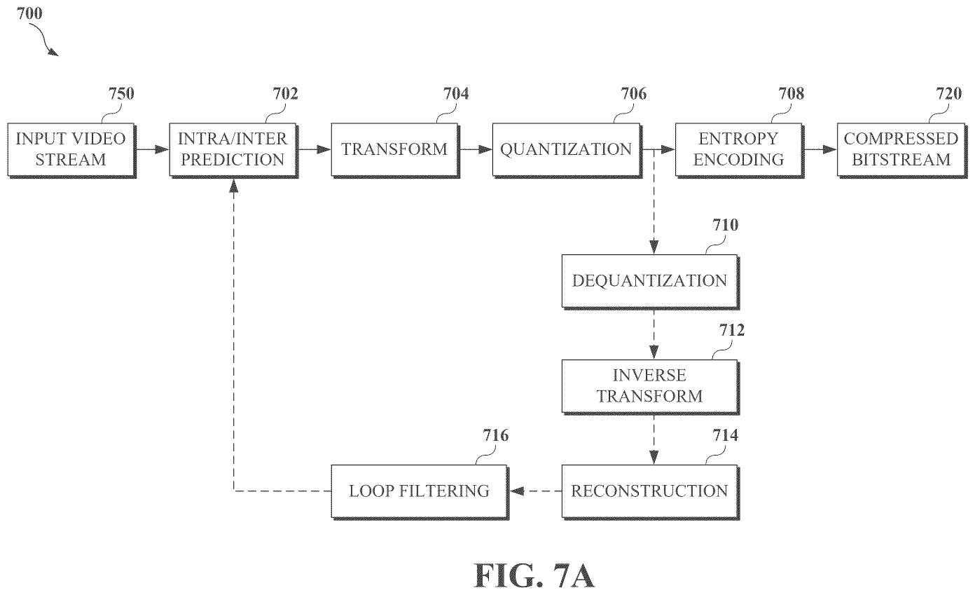

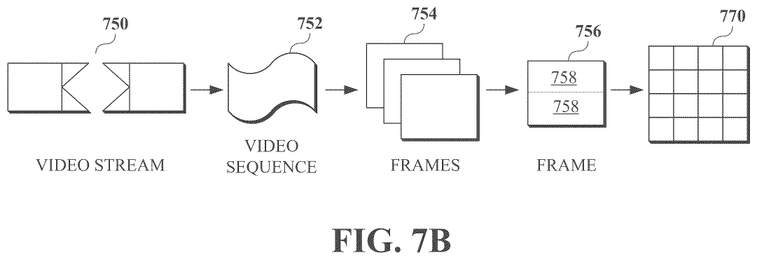

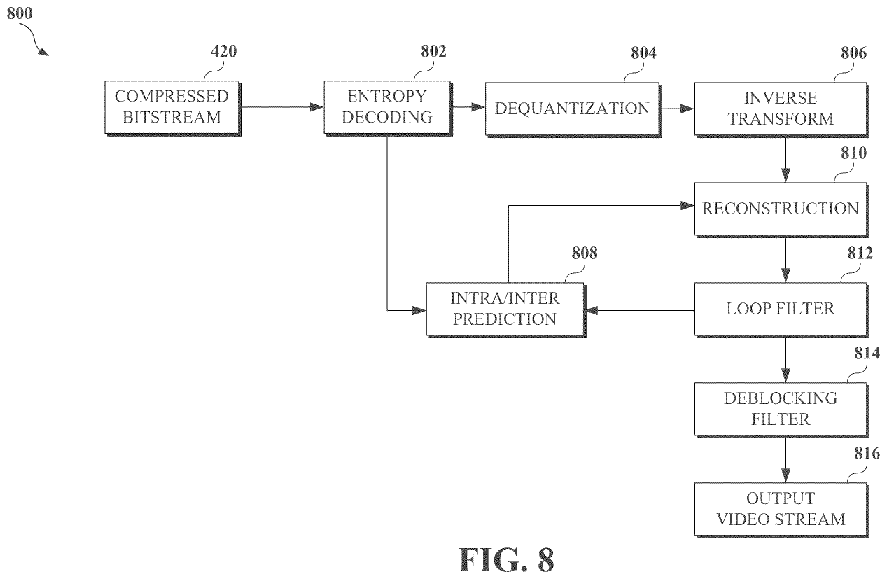

The transcoder 114 receives the segment 108 along with the selected transcoding parameters. The transcoder 114 then performs the transcoding process, which involves re-encoding the video according to the specified parameters. The output is a transcoded video 116 (e.g., a transcoded video file) that is optimized for distribution or playback, balancing quality and compression to suit the target platform or network conditions. The transcoder 114 may convert the segment 108 into another bit stream with different formats than that of the video 104. Such different formats can include resolution, bit rates, and other variable parameters. The transcoder 114 may be, may implement, or may include an encoder, such as the encoder described with respect to FIG. 7A. The transcoded video 116 may be decoded by a decoder described with respect to FIG. 8.

FIG. 2 is a block diagram of an example of a computing device 200. The computing device 200 can implement the controller 106 and/or the transcoding parameter selector 112 of FIG. 1. The computing device 200 may include the quantized CNN 102 and/or the transcoder 114 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include a video coding application that performs the techniques described herein. The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

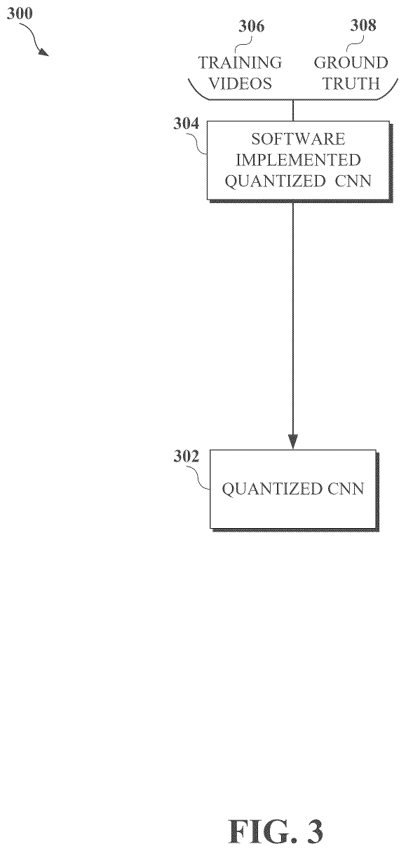

FIG. 3 is a block diagram of a high level process 300 of obtaining a quantized CNN 302, which can be the quantized CNN 102 of FIG. 1. A software implemented quantized (SIQ) CNN 304 is first trained. After the SIQ CNN 304 is trained, the quantized CNN 302 is obtained (e.g., designed and built) therefrom. That is, the quantized CNN 302 is a hardware implementation of the SIQ CNN 304.

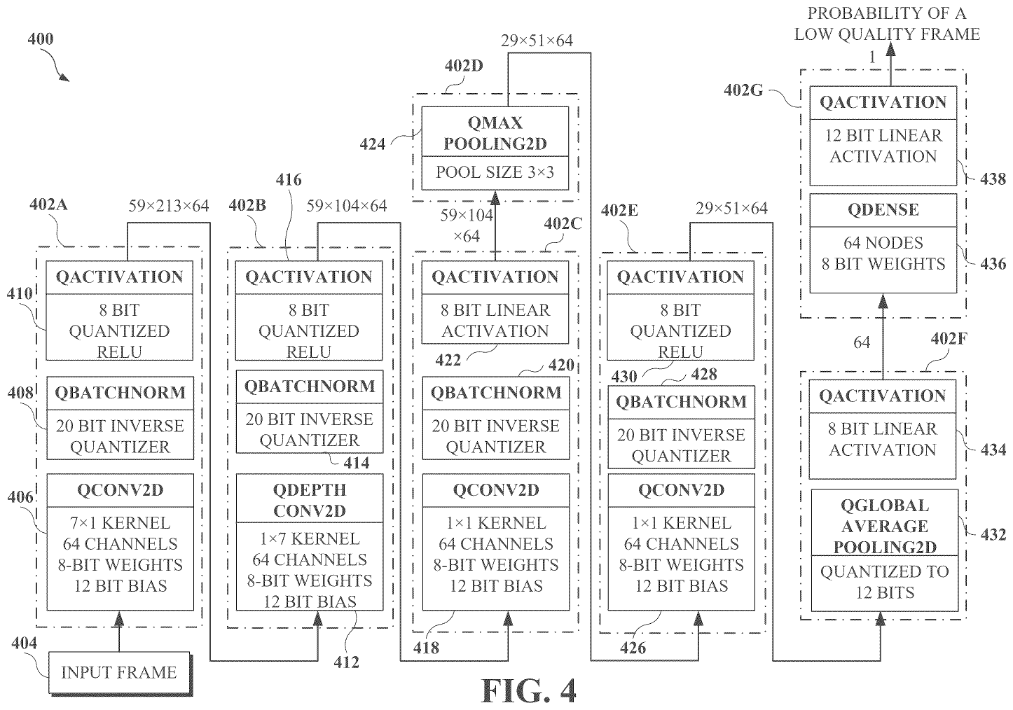

A set of training videos 306 and corresponding ground truth 308 are used to train the SIQ CNN 304. A training video may be associated with an average subjective quality score (e.g., a ground truth) obtained from humans. To illustrate, and without limitations, every video in the in the training videos 306 may be watched by N (e.g., 3 or 5) persons who each assigns a quality score (e.g., a value between 1 and 5) indicating their subjective opinions of the quality of the video. The ground truth value associated with a video can be the average the N quality scores. As described with respect to FIG. 1, the quantized CNN 302 receives frames of segments of videos. Thus, the SIQ CNN 304 receives videos frames as input. As a simplification, each frame of a video is assumed to have the same ground truth quality score associated with the whole video. The architecture and training of the SIQ CNN 304 are further described with respect to FIG. 4.

FIG. 4 illustrates an architecture of an SIQ CNN 400, which can be the SIQ CNN 304 304 of FIG. 3. The SIQ CNN 400 is designed for the task of predicting the probability of a low-quality frame in a video (e.g., an input 404). The SIQ CNN 400 includes 7 layers; namely, layers 402A-402G.

Each of the layers 402A-402G can be a group of operations (also referred to herein as layers). For example, a convolution layer (e.g., the layer 406 amongst others) is a group of operations starting with a Convolution2D operation (i.e., layer) followed by zero or more operations (e.g., Pooling, Dropout, Activation, Normalization, BatchNormalization, other operations, or a combination thereof), until another convolutional layer, a Dense operation, or the output of the CNN is reached. A convolution layer can use (e.g., create, construct, etc.) a convolution filter that is convolved with the layer input to produce an output (e.g., a tensor of outputs).

The input 404 to the SIQ CNN is a video frame of size M×N. More specifically, the input 404 can be the luminance channel only. If an original frame that is to be used as the input 404 is larger than M×N, then the original frame may be down-sized, down-sampled, or down-scaled to be of size M×N. In an example, M can be 240 pixels and N can be 213 pixels. As such, no color (e.g., chrominance) information is input to the SIQ CNN. Additionally, no temporal information is input to or used by the SIQ CNN 400. That is, the SIQ CNN does not receive a sequence of frame that it attempts to identify motion information therebetween. That is, the SIQ CNN is run (e.g., executed) once per frame. The input 404 may be obtained from an original frame by rotating the original frame. Rotating an original frame to obtain the input 404 has been shown to reduce activation storage.

The SIQ CNN 400 includes several layers designed to perform a series of transformations on the input 404. These layers include convolutional layers, batch normalization layers, activation layers, pooling layers, and dense layers. Each layer contributes to the network's ability to discern (e.g., learn) features indicative of low-quality frames.

The layer 406 (QCONV2D layer) applies a convolution operation with a 7×1 kernel across 64 channels. That is, 64 different 7×1 kernels (e.g., filters) are applied to the input 404 during the convolution operation. Each filter, when convolved with the input data, produces a unique feature map. The collection of the 64 feature maps forms the complete output of the convolutional layer (e.g., the layer 406).

The layer 406 utilizes 8-bit weights and a 12-bit bias to transform the input data. The bias serves as an additional parameter that is added to the output of the weighted input data and kernel transformations prior to the application of the activation function (e.g., the layer 410). The bias is added to the convolutional operation outputs in the layer 406, and then this result undergoes normalization in the layer 408, before the activation function in the layer 410 (the ReLU function) is applied. Thus, the bias helps to adjust the input of the activation function post-normalization for the subsequent non-linear transformation.

The layer 408 (QBATCHNORM layer) incorporates a 20-bit inverse quantizer for normalization purposes (further described below). Layer 410 (QACTIVATION layer) employs an 8-bit quantized ReLU activation function to introduce non-linearity to the transformation process. The output of the layer 402A is a feature map that has the dimensions 59×213×64, where “59” indicates the height of the feature map, “213” represents the width of the feature map, and “64” corresponds to the number of channels or depth of the feature map.

The layer 412 (QDEPTHWISECONV2D layer) utilizes a 1×7 kernel to convolve each input channel separately. It maintains the 64-channel structure with 8-bit weights and a 12-bit bias. As is known, DepthwiseConv2D is a type of convolutional layer that, unlike the standard convolutional layer that applies filters to the entire depth of the input volume, performs a single convolution per each input channel (depth). The layer 414 (QBATCHNORM layer) continues the normalization process with a 20-bit inverse quantizer. This is followed by the layer 416 (QACTIVATION layer) that utilizes an 8-bit quantized ReLU function. The output of the layer 402B is a feature map that has the dimensions 59×104×64.

The layer 418 (QCONV2D layer) is a convolutional layer that employs a 1×1 kernel with 64 channels, using 8-bit weights and a 12-bit bias to further refine the features extracted from the input data. The layer 420 (QBATCHNORM layer) includes a 20-bit inverse quantizer for continued normalization. The layer 422 (QACTIVATION layer) is an activation layer with an 8-bit linear activation function. The output of the layer 402C is a feature map that has the dimensions 59×104×64.

The layer 424 implements a MaxPooling2D operation with a pool size of 3×3 to reduce the spatial dimensionality of the data, enhancing the focus of the SIQ CNN 400 on salient features. is a type of layer often used in convolutional neural networks (CNNs), especially in the context of image processing. The role of the layer 424 is to reduce the spatial dimensions (width and height) of the input volume for the subsequent convolutional layers. It operates by sliding a window (in here, 3×3 window) across the input volume and outputting the maximum value within each window's coverage area. The output of the layer 402D is a feature map that has the dimensions 29×51×64.

Following the pooling operation, the layer 426 (QCONV2D layer) is another convolution layer with a 1×1 kernel and 64 channels, utilizing 8-bit weights and a 12-bit bias. The layer 428 (QBATCHNORM layer) applies a 20-bit inverse quantizer, and this is followed by the layer 430 (QACTIVATION layer), which is an activation layer with an 8-bit quantized ReLU function. The output of the layer 402E is a feature map that has the dimensions 29×51×64.

The layer 432 (QGLOBALAVERAGEPOOLING2D) is a global average pooling 2D layer that averages the features across the spatial dimensions, quantized to 12 bits, to produce a feature vector that captures the essence of the quality of the input 404. The layer 432 performs spatial averaging on the entire input for each feature channel, reducing the spatial dimensions (height and width) of the input to a single average value per channel, which results in a significant reduction of the dimensionality of the data by converting a 2D feature map into a single scalar value per feature map channel. The layer 432 reduces the number of parameters, mitigates the risk of overfitting by providing an abstracted form of the input features, and is particularly useful for transitioning from convolutional layers to fully connected layers (e.g., the layer 436). The output of the layer 402F is/are 64 features, each quantized to 8 bits, providing a condensed representation of the input data's essential characteristics for further processing or classification.

The SIQ CNN 400 concludes with the layer 434, which is a layer with an 8-bit linear activation function, the layer 436 (QDENSE layer), which is fully connected layer with 64 nodes with 8-bit weights, and the layer 438, is an activation layer that produces the final output—a 12-bit linear activation value representing the probability of the input frame being of low quality.

During training, the batch normalization layers of the SIQ CNN 400 (such as the layers 408, 414, 420 and 428) stabilize the learning process and speed up convergence by normalizing the inputs to each layer subsequent layer, which reduces internal covariate shift. During inference, these layers maintain the normalization parameters learned during training to ensure consistent output behavior.

The prefixes “Q” in the names of layers 406-438 depicted in FIG. 4 signify their quantized nature, highlighting that these components are designed for quantization. Quantization effectively reduces the overall size of the SIQ CNN 400 and results in significant decreases in energy consumption. For instance, utilizing int8 operations instead of float32 can achieve an energy consumption reduction by a factor of 16, while employing binary operations in place of float32 operations can amplify this reduction to a factor of 1024. Furthermore, quantization contributes to decreased latency and memory demands therewith enhancing the efficiency and performance of the SIQ CNN 400.

QKeras is utilized in the design of the SIQ CNN 400. QKeras is an extension of the Keras library that specializes in quantized neural networks, enabling reduced precision arithmetic for models to enhance efficiency and performance. Keras is a high-level neural networks Application Programming Interface (API) designed for easy and fast prototyping, supporting both convolutional and recurrent networks. QKeras allows for (e.g., enables) precise control over the bit-width of weights, activations, and biases within each layer, enabling the model to operate with reduced precision arithmetic.

The SIQ CNN 400 is designed to exclusively use quantized operations, eliminating the use of any floating-point computations. This is a significant departure from conventional practices where, despite the application of quantization to layers, a certain degree of floating-point operations is still executed. Typically, operations such as batch normalization and activation functions persist in utilizing floating-point arithmetic, with batch normalizations alone constituting up to 40% of the computational workload. Unlike these conventional approaches, where the quantizer of a layer typically relies on floating-point scales, the SIQ CNN 400 employs quantization scales that are not based on floating-point representations, enhancing both computational efficiency and precision.

Layers of the SIQ CNN 400 are configured with respective quantizers. A quantizer divides a continuous space into discrete bins. At least some of the quantizers are designed (e.g., configured) to perform shift operations rather than multiplication operations. Shift operations are significantly more hardware-friendly than multiplication operations. As such, the hardware-implemented version of the SIQ CNN 400 (e.g., the quantized CNNs 102 or 302) need not include multipliers.

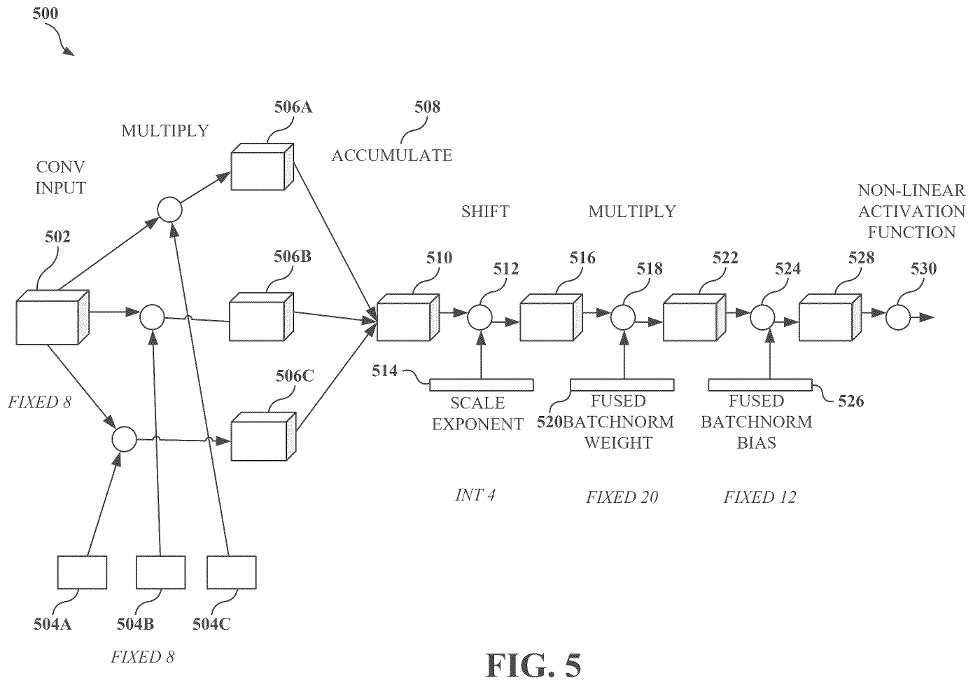

To illustrate, a convolutional layer may be defined using the following line of code. QConv2D(s) specifies a 2D convolutional layer using QKeras, which is quantized to use fixed-point numbers instead of floating-point numbers. This layer has 64 filters (or kernels). That is, the layer outputs 64 feature maps each of size 7×1. kernel_size=(7,1) indicates that the convolutional window (kernel) is of size of 7×1, meaning that it will span 7 elements in one dimension and 1 element in the other, effectively capturing patterns over 7 adjacent elements in one direction. use_bias=True indicates that a bias vector is added to the output feature maps. The strides=2 parameter indicates that the convolutional filters will move 2 pixels at a time as they pass over the input data. kernel_quantizer=quantized_bits(bits=8, alpha=“auto_po2”) defines the quantization method for the weights of the convolutional kernels where quantized_bits(8,alpha=“auto_po2”) means that the weights are quantized to 8 bits, and the scaling factor alpha is automatically adjusted based on a power of 2, which can be implemented using shift operations for the scale (as shown in FIG. 5 with respect to the shift operation 512), where the weights is in 8 bits and a standard fixed point multiplier can be used in the hardware. bias_quantizer=quantized_bits(21, 2, symmetric32 True, keep_negative=True) sets the quantization method for the biases of the convolutional layer. The biases are quantized to 21 bits with 2 bits for the fractional part. The symmetric=True parameter indicates that the quantization will be symmetric around zero, and keep_negative=True indicates that negative values are allowed.

$$x = QCo nv 2 D ( filters = 64 , kernel\_zize ( 7 , 1 ) , use\_bias = True , passing = ‘ valid ’ , strides = 2 , kernel\_quantizer = quantized \_bits ( 8 , alpha = “ auto\_po 2 ” ) , bias\_quantizer = quantized \_bits ( 21 , 2 , symmetric = True , keep\_negati ve = True ) ) ( x )$$

The SIQ CNN 400 use power-of-two quantization scales to optimize the hardware implementation. This technique is predicated on the principle that a quantizer scale(s) is inversely proportional to a power of two, specifically

$$S = \frac{1}{{{{S}^{bits}}_{}}^{}} .$$

For instance, with a 4-bit quantizer, the scale would be 1/16, which simplifies to 0.0625. This scale is utilized in the quantization function q(x)=int(x>>log₂(s))<<log₂(s) where ‘>>’ and ‘<<’ denote bitwise shift operations to the right and left, respectively, which are used in place of multiplication or division by the scale factor. These operations significantly reduce the computational cost on hardware, as shift operations are more efficient to execute than multiplications or divisions.

A distinguishing design feature of the SIQ CNN 400 is how batch normalization is calculated/performed. As mentioned, batch normalization layers are typically used to stabilize the training and improve their performance. Batch normalization is conventionally computed using equation (1), where x is an input feature map and the batch norm parameters μ, γ, σ, and β (which correspond, respectively, to the batch mean, a learned scaling parameter, standard deviation of the batch, and a learned shifting parameter) are represented as floating-point values. ϵ is a small constant that is added to the variance to prevent division by zero and improve numerical stability.

$$batchnorm ( x ) = \frac{( x - μ ) * γ}{\sqrt{{σ}^{{}_{2}} + ϵ}} + β \qquad ( 11 )$$

One approach to quantizing the batch normalization operations is shown in equation (2) where each constituent of equation (1) is separately quantized, as indicated by the function q(·). However, as can be seen in this conventional approach to quantizing the batch norm, the expensive division and the square root operations are still performed.

$$batchnorm ( x ) = \frac{( x - q ( μ ) ) * q ( γ )}{\sqrt{q ( {σ}^{{}_{2}} ) + ϵ}} + q ( β ) \qquad ( 22 )$$

To overcome these problems, the SIQ CNN 400 uses what is referred to herein as “quantizing the inverse part of the batch norm.” In quantizing the inverse part of the batch norm, the batch norm quantization operation can be rewritten into equation (3) where the input x is first multiplied by a quantized scale s followed by adding a quantized bias b.

$$Qbat c h n o r m ( x ) = x * s - b \qquad ( 33 )$$

$$s = q ( \frac{γ}{\sqrt{q ( {σ}^{2} ) + ϵ}} ) \qquad ( 44 )$$

$$b = q ( β ) - q ( μ ) * s \qquad ( 55 )$$

The quantized scale s is represented as the quantized division between the γ and σ parameters, as shown in equation (4); and the quantized bias b is calculated using equation (5). Inverse Quantization reduces quantization error by allowing high precision division in the scales computation during training.

After training, the quantized scale s is pre-computed to avoid high precision division during inference. As such, during inference, in the quantized CNN 102 or 302, the hardware implementation only requires a single additional, low precision, fixed-point multiplication to implement the equivalent of a batch normalization layer (such as each of the layers 408, 414, 420, and 428). The subtraction of equation (5) can be integrated into a previous adder; and the multiplication operation can be kept as a separate additional multiplication in the hardware. That is, the multiplication operation can be implemented using a dedicated multiplier component. Equation (3) amounts to computationally inexpensive 8-bit multiplication and subtraction operations.

Another distinguishing feature of the SIQ CNN 400 is the use of a 7×1 kernel in the layer 406 and 1×7 kernel in the layer 412. More generally, the kernels could be N×1 and 1×N. Conventionally, kernels are much smaller and rectangular (e.g., 3×3). By using bigger kernels, the SIQ CNN 400 can “see” (e.g., examine, consider, analyze, or evaluate) wider or taller portions of the input 404, which enables the SIQ CNN 400 to find (e.g., identify or learn) patterns that are less localized than those found by smaller kernels. The SIQ CNN 400 can make better decisions when it is able to see larger portions of the input. While the kernels may be made bigger (e.g., 7×2 or 7×3 and 2×7 or 3×7), bigger kernels have the associated costs of larger matrix multiplications. To simplify the computations, the SIQ CNN 400 is architected to separately (e.g., in different layers) analyze the horizontal and the vertical dimensions of the input 404. The combination of the using the depthwise 1×7 kernels in the layer 412 and using luma input to the SIQ CNN 400 has been shown to result in an 82% reduction in the number of parameters of SIQ CNN 400 as compared to using 2-dimensional kernels and all of the color components as input data.

Another distinguishing feature of the SIQ CNN 400 is the loss function used for training. The loss function essentially guides the optimization of the CNN during training. Conventionally, commonly used loss functions include Mean square error (MSE), pairwise loss between different encoding levels, contrastive loss between different encoding levels, and fusion linearity monotonicity loss.

The MSE measures the average squared difference between estimated values (outputs of a CNN) and actual values (e.g., the ground truth values). Pairwise loss functions compare the predictions at different encoding levels within a network to ensure that relative distances or similarities are preserved. Contrastive loss can be used in tasks that involve learning embeddings or representations, where the goal is to ensure that similar data points are brought closer in the feature space, while dissimilar points are pushed apart. Fusion linearity and monotonicity loss functions are designed to enforce a linear or monotonic relationship between the model's inputs and outputs. However, implementing and calculating such loss functions is complex in the context of hardware-implemented quantized CNN.

The SIQ CNN 400 incorporates a tailored loss function that better aligns with the perceptual quality assessment of video frames. A loss function that is based on the Pearson Linear Correlation Coefficient is used. The Pearson Linear Correlation Coefficient is a number between −1 and 1 that measures the strength and direction of the relationship between two variables. In the case of SIQ CNN 400, the two variables are the ground truth quality score values and the quality scores output by the SIQ CNN 400. More specifically, the negative squared Pearson linear correlation coefficient, as shown in equations 6(a) and 6(b).

$$L ( X , Y ) = - {( PearsonCoefficient )}^{2} \qquad ( 66 a )$$

$$PearsonCoefficient = \frac{{\sum }_{i = 1}^{n} ( {X}_{i} - {μ}_{X} ) ( {Y}_{i} - {μ}_{Y} )}{\sqrt{{( {\sum }_{i = 1}^{n} ( {X}_{i} - {μ}_{X} ) )}^{2} {\sum }_{i = 1}^{n} {( {Y}_{i} - {μ}_{Y} )}^{2}}} \qquad ( 66 b )$$

Equation (6b) is the standard formula for calculating the Pearson Coefficient, where the X denotes the ground truth quality scores of a training batch, Y denotes the quality scores output by the SIQ CNN 400 for the training batch, μ_{X} denotes the mean of the ground truth quality scores of the training batch, μ_{γ} denotes the mean of the quality scores of the training batch output by the SIQ CNN 400, and n denotes the batch size. The negative is used because, while loss functions are generally minimized, herein it is desirable to maximize the Pearson Linear Correlation Coefficient. Additionally, the square is used so that a strong correlation can be obtained regardless of whether the correlation is −1 or 1. Using the square enables the removal of the negative and the maximizing of the total correlation, even if that correlation is inverted (since it can be easily un-invert after the training ends).

By adopting the negative squared Pearson correlation coefficient as the loss function, the SIQ CNN 400 can effectively handle a regression task rather than classification, focusing on the continuous spectrum of quality ratings. A large batch size (e.g., n=4096) is used to facilitate the ability of the SIQ CNN 400 to discern patterns across a larger dataset, which can be especially beneficial for learning from outliers. The utilization of the correlation as the training loss function enables the SIQ CNN 400 to refine its weight adjustments based on a collective assessment of the model's output in relation to human evaluations, leading to a more robust and human-aligned video quality prediction model.

Yet another distinguishing design feature of the SIQ CNN 400 is the inclusion of the pointwise layers (i.e., the layers 418 and 426), which use 1×1 kernels. While a cost is associated with these layers (such as in terms of weights to be learned), they enable more model capacity, enabling the SIQ CNN 400 to recognize and learn more patterns in the input 404. A conventional or traditional approach would have been to use any number of large convolution layers, which would introduce significantly more parameters into the SIQ CNN 400 model. As such any benefits gained from such layers would be negated by their costs. The layers 418 and 426 are noteworthy because they are pointwise layers that operate on some, but not all, of the dimensions of the input. More specifically, while full-size convolutional layers look at spatial patterns and relationships, pointwise layers focus on combining features across channels at each individual spatial location.

The pointwise layers are hardware efficient and their locations in the SIQ CNN 400 (e.g., after the convolution and depth-wise layers but immediately before the dense layers) improve the model's accuracy without adding many parameters. The main function of pointwise convolutions is to combine or transform the feature channels without affecting the spatial dimensions of the input volume. They provide a way to increase or decrease the depth (number of channels) of the feature maps. Pointwise layers are computationally less expensive due to the smaller size of the kernels. Each 1×1 filter requires fewer weights and performs fewer operations per spatial location compared to larger kernels. While adding the pointwise layers (e.g., the layers 418 and 426) was shown to increase the number of parameters by 11%, the combination of the pointwise layers with the use of the Pearson Linear Correlation Coefficient results in improved accuracy (e.g., correlation) of the model by 21.5%.

Another distinguishing design feature is the removal of the sigmoid function from the last layer (e.g., the layer 438) that outputs a normalized prediction of low quality video between 0.0 and 1.0. The sigmoid function is shown in equation (7), where x is the input to the sigmoid function.

$$S ( x ) = \frac{1}{1 + {e}^{- x}} \qquad ( 77 )$$

Calculating the sigmoid in hardware is expensive due to the exponential and division operations. To overcome these problems, calculating sigmoid can be omitted (e.g., avoided) by rearranging the formula in equation (7) with respect to a classification threshold, T, which is precomputed or preselected. The threshold T delineates the boundary between probability values output by the model that identify a video as probably of low quality vs probably of not low quality (e.g., probably of high quality. The threshold T can be derived by examining (e.g., calculating) the trade-offs between recall, precision, and false positive rate across various threshold levels. The threshold value that optimizes these metrics can be selected as the threshold T. For the SIQ CNN 400, it was determined that T=0.64 can effectively differentiate between high and low-quality frames.

If a calculated sigmoid value for an input x is greater than the threshold T, then the model can infer (e.g., output) that the input 404 is of high quality (e.g., that there is a low probability that the frame has low quality); conversely, if the calculated sigmoid value for the input x is less than the threshold T, then the model can infer (e.g., output) that the input 404 is of low quality (however, the opposite can also be implemented). Accordingly, it can be evaluated whether S(x)>T, which can be rearranged as shown in the series of equations (8).

$$\{ \begin{matrix}S ( x ) > T \\ \frac{1}{1 + {e}^{- x}} > T \\ \frac{1}{T} - 1 > {e}^{- x} \\ ln ( \frac{1}{T} - 1 ) > - x \\ x < - ln ( \frac{1}{T} - 1 )\end{matrix} \qquad ( 88 )$$

As such, the input x can merely be compared to a the constant

$$- ln ( \frac{1}{T} - 1 ) ,$$

which can easily (e.g., inexpensively) be implemented in hardware (e.g., in one of the quantized CNNs 102 or 302). The input x is the logit (i.e., the activation value before the sigmoid function is applied). In machine learning, a logit refers to the inverse of the sigmoid function, which is used to map real numbers to probabilities between 0 and 1, enabling the application of linear models in classification tasks. To restate, x is the logit and S(x) is the normalized output of the model indicating the probability of a low quality frame by use of the sigmoid function. S(x)>T is a Boolean value indicating whether the probability is large enough so that the frame can be classified as being of low quality or not being of low quality. In some implementations, the quantized CNN outputs x and another component (such as the parameter selector 112 of FIG. 1) may use the x value to determine whether to simply normalize it with S(x) or to alternatively apply the threshold value by computing x<−ln(1/T−1).

FIG. 5 is a block diagram of a structure 500 of a quantized convolutional layer as implemented in hardware. The hardware implements an Application-specific machine learning (ASML) model. The structure 500 illustrates a hardware implementation of a convolutional layer. The structure 500 or a similar structure can be used to implement one of the layers 402A, 402B, 402C, or 402E of FIG. 4.

Distinguishing implementation features of the structure 500, and as further described herein, include the parallel processing of multiplication operations and the fusion of convolution and batch normalization operations to streamline the computational flow. By integrating these operations into discrete blocks within the hardware, the design achieves a more compact and faster processing unit. Additionally, the use of quantized weights, biases, and scale factors reduce computational load and computational resources (e.g., logic gates).

The structure 500 operates on an input 502. That is, the convolution operation is to be performed on the input 502. The input 502 can be a multi-dimensional array (tensor) that represents a feature map from a previous layer or the original input to the network. For example, with respect to the layer 402A, the input 502 can be the input 404; and with respect to the layer 402B, the input 502 can be the feature map having the dimensions 59×213×64. To implement the trained SIQ CNN 400 in hardware, the structure 500 can be repeated (and adapted) for each of the convolution layers (e.g., layers 402A, 402B, 402C, and 402D) of FIG. 4.

Kernels 504A-504C represent the convolutions filters. For brevity and illustrative purposes, only three kernels are shown in FIG. 5. However, the number of kernels can be according to the description of the layers of FIG. 4. The weights of the kernels are learned during the training process of the SIQ CNN 400 of FIG. 4. The kernels 504A-504C are applied to the input 502 to extract features. The kernels 504A-504C are quantized to 8 bits (fixed 8), meaning that their values are represented with 8-bit precision, reducing the model's complexity and computational cost. The multiplication operations of the convolution operations are carried by the structure 500 in parallel, which enables simultaneous processing thereby speeding up the computations. The multiplication operations involve element-wise multiplication of the input 502 with the weights of the kernels 504A-504C. The convolution operations result in outputs 506A-506C.

An accumulate operation 508 adds up the multiplied values to produce a single output for each location on the input 502. The accumulate operation 508 produces an output 510, which may be a multi-dimensional (e.g., 3-dimensional) output. The output 510 is then subjected to a shift operation 512. The shift operation 512 (i.e., bit-shift operations), which is a key point of optimization, replaces the more common and computationally expensive floating-point multiplication typically used for scaling. The output 510 is scaled by a factor determined by a scale exponent 514 that is represented with 4-bit integers (int4). The shift operation 512 utilizing the 4-bit integer scale exponent 514 scales the output values of the feature map 510 efficiently by powers of two therewith leveraging (e.g., implementing) the fact that bit shifting is a lower-cost operation in hardware terms. The shift operation 512 produces a feature map 516.

The next stage implements a fused batchnorm operation 518 and a fused batchnorm bias operation 524. Batch normalization is implemented as described with respect to equations (3)-(5). “Fused Batchnorm” refers to the integration of batch normalization parameters directly into the weights and biases of the convolution operation. Instead of performing batch normalization as a separate layer, the weights and biases are adjusted to account for the normalization step. The ‘Fused Batchnorm Weight’ and ‘Fused Batchnorm Bias’ operations are performed with (e.g., quantized to) 20-bit (using a fused batch norm weight 520) and 12-bit precision (using a fused batch norm bias 526), respectively. As already mentioned, fusing these operations into a single hardware step reduces the complexity and increases the efficiency of the quantized CNN. The single (e.g., fused) hardware step is an additional high precision multiplication that is applied after the reduction, in which the Fused Batchnorm Weight is applied as described with respect to the inverse batchnorm s parameter. The Fused Batchnorm Bias is applied as described with respect to the inverse batchnorm b parameters.

After the convolution operation, an activation function 530 is applied to the output 528. A non-linear activation function, such as a ReLU, is shown. As described with respect to FIG. 4, the activation function can be a linear activation function.

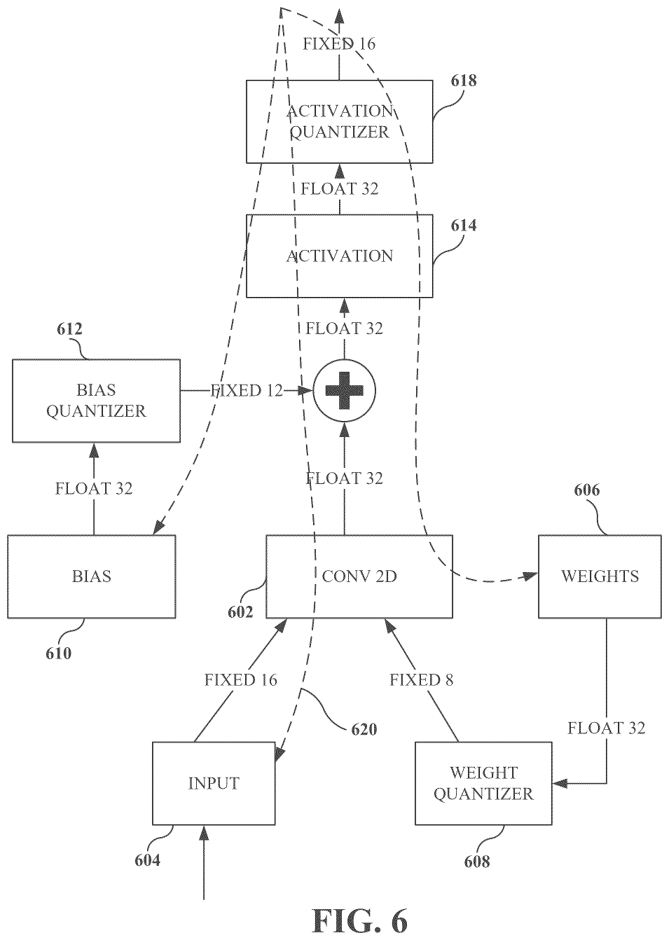

FIG. 6 illustrates quantization aware training of the SIQ CNN 400 of FIG. 4. The training process uses simulated and heterogeneous quantization.

Simulated quantization is used to train the SIQ CNN 400 for quantized operations. Hardware is primarily capable of high-precision, floating-point multiplications. Simulated quantization simulates the effects of low-precision, quantized operations during training, even though the underlying hardware operates on floating-point math. This simulation allows the SIQ CNN 400 to learn as if it were running on the target low-precision hardware (e.g., the quantized CNNs 302 of FIG. 3). Via quantizers, simulated quantization essentially removes information from the high-precision weights as if it were the low precision hardware.

Heterogeneous quantization refers to applying different quantization precisions to various parameters within the SIQ CNN 400 of FIG. 4. Rather than uniformly quantizing all weights to the same precision level, such as 8-bit integers, heterogeneous quantization allows for a tailored approach where some weights might be quantized to 8-bit integers, while others could be to 7-bit integers or any other precision level deemed optimal. Accordingly, not all parameters of the SIQ CNN 400 require the same level of precision to maintain model performance.

During training, quantization effects are simulated in the forward pass of training by implementing, in floating-point arithmetic, the rounding behavior of a quantization scheme (described below). All weights and biases are stored as floating point values. The forward pass refers to processing input through the SIQ CNN 400 to generate an output (e.g., the probability of low quality frame). That is, during the forward pass, the inputs pass through the quantized layers. However, the simulation of quantization occurs when they are used in computations. That is, although the weights and activations are stored in full precision, they are quantized (rounded to the nearest value within the quantization scheme) prior to being used in computations.

To illustrate, a convolution layer 602 (which may be or may be similar to one of the layers 406, 412, 418, or 426 of FIG. 4) receives an input 604. The convolution layer 602 does not directly use weights 606, which may be stored as float 32 values. Rather, the weights are converted to a lower precision format, such as fixed-point or integer, by a quantizer 608. That is, weights are quantized before they are convolved with the input 604. If batch normalization is used, the batch normalization parameters are “folded into” the weights before quantization.

FIG. 6 illustrates that the quantizer 608 converts the weights into fixed 8 values. However, other fixed number formats may be used. Float 32, also known as single-precision floating-point format, is a computer number format that occupies 32 bits (4 bytes) in computer memory. In this format, numbers may be expressed using the Institute of Electrical and Electronics Engineers standard IEEE 754 for floating-point arithmetic. On the other hand, fixed N (where N can be 8, 12, 16, etc.) denotes a fixed-point numerical representation system in which numbers are encoded using N bits. This format enables a streamlined and resource-efficient computational approach, optimizing for both memory usage and processing speed, particularly advantageous in environments constrained by hardware capacity.

Similarly, a bias 610, which can also be stored as a float 32 value, is converted by a quantizer 612 into a fixed 12 value. Additionally, activations may be quantized at points where they would be during inference. As such, after an activation function 614 is applied (to a convolutional or fully connected layer's output, as the case may be), a quantizer 618 converts the float 32 values into another lower precision format (e.g., fixed 16, as shown in FIG. 6).

After the forward propagation of a batch of n samples (e.g., n=4096), the predictions of the SIQ CNN 400 are compared to the ground truth values based on the negative squared Pearson linear correlation coefficient loss function, as described above. The error is then backpropagated through the SIQ CNN 400.

During backpropagation gradients of the loss function with respect to the network parameters are calculated and propagated backwards through the SIQ CNN 400 to update the weights, with the purpose of minimizing the loss and improving predictions. Full-precision gradients may be used to update the full-precision parameters of the SIQ CNN 400. As illustrated by the dashed lines of FIG. 6, the full-precision (e.g., float 32) weights and the bias 610 are updated using these gradients, often with some form of gradient descent algorithm, such as Stochastic Gradient Descent (SGD) or some other backpropagation technique. An arrow 620 illustrates that backpropagation of the gradients continues to go backwards to the preceding layer(s).

After the weights and bias have been updated, they are quantized again, and the next forward pass uses these new quantized weights. This cycle ensures that the SIQ CNN 400 learns to compensate for the quantization that will occur during inference on the low-precision hardware.

A quantizer (such as one of the quantizer 608, the quantizer 612, or the quantizer 618), is configured to convert a continuous range of values into a finite set of discrete bins. The quantizer is configured with two parameters: a scale and a number of bins. The scale defines the range each bin covers, and the number of bins determines the total number of discrete values that the continuous space is divided into.

The quantizer can be mathematically described as follows: for any real-valued number r to be quantized within a specific range [a, b], the quantizer first clamps r to the range [a, b]. The clamping function can be as shown in equation (9a). The clamping function clamp ) effectively restricts r within the bounds of a and b. The scale s is computed by dividing the range b-a by the number of bins n minus one, as shown in equation (9b). The quantizer applies a quantization function q(r; a, b, n) that can be given by equation (9c). The function int(·) rounds to the nearest integer. As such, the value

$$\frac{clamp ( r ; a , b ) - a}{s ( a , b , n )}$$

is rounded to the nearest integer and then scaled back based on the scaling function and then the minimum range value a is added.

$$clamp ( r ; a , b ) = min ( max ( x , a ) , b ) \qquad ( 9 a )$$

$$s ( a , b , n ) = \frac{b - a}{n - 1} \qquad ( 9 b )$$

$$q ( r ; a , b , n ) = int ( \frac{clamp ( r ; a , b ) - a}{s ( a , b , n )} ) s ( a , b , n ) + a \qquad ( 99 c )$$

The scaling function of equation (9c) maps the continuous input r to its nearest quantized value within the specified range and number of bins. For example, if n is 2⁸ or 256, this signifies an 8-bit quantization where the continuous input values are mapped to one of 256 discrete levels.

FIG. 7A is a block diagram of an encoder 700. The encoder 700 can be implemented, as described above, in a transmitting device, which may be as described with respect to FIG. 2, such as by providing a computer software program stored in memory, for example, the memory 204. The computer software program can include machine instructions that, when executed by a processor such as the processor 202, cause the transmitting device to encode video data in the manner described in FIG. 7A. The encoder 700 can also be implemented as specialized hardware included in, for example, a transmitting station. In one particularly desirable implementation, the encoder 700 is a hardware encoder. The encoder 700 can also be implemented by a transcoder, such as the transcoder 114 of FIG. 1.

The encoder 700 has the following stages to perform the various functions in a forward path (shown by the solid connection lines) to produce an encoded or compressed bitstream 720 using a video stream 750 as input: an intra/inter prediction stage 702, a transform stage 704, a quantization stage 706, and an entropy encoding stage 708. The encoder 700 may also include a reconstruction path (shown by the dotted connection lines) to reconstruct a frame for encoding of future blocks.

In FIG. 7A, the encoder 700 has the following stages to perform the various functions in the reconstruction path: a dequantization stage 710, an inverse transform stage 712, a reconstruction stage 714, and a loop filtering stage 716. Other structural variations of the encoder 700 can be used to encode the video stream 750. The video stream 750 is further described with respect to FIG. 7B. As described above, the video stream 750 may be provided to the encoder 700 as segments, as described with respect to segment 108 of FIG. 1. While not specifically shown in FIG. 7A, the encoder 700 may also receive encoding parameters for a segment, as described with respect to parameter selector 112 of FIG. 1.

FIG. 7B is a diagram of an example of a video stream 750 to be encoded and subsequently decoded. The video stream 750 includes a video sequence 752. At the next level, the video sequence 752 includes a number of adjacent frames 754. While three frames are depicted as the adjacent frames 754, the video sequence 752 can include any number of adjacent frames 754. The adjacent frames 754 can then be further subdivided into individual frames, for example, a frame 756. At the next level, the frame 756 can be divided into a series of planes or segments 758. The segments 758 can be subsets of frames that permit parallel processing, for example. The segments 758 can also be subsets of frames that can separate the video data into separate colors. For example, a frame 756 of color video data can include a luminance plane and two chrominance planes. The segments 758 may be sampled at different resolutions.

Whether or not the frame 756 is divided into segments 758, the frame 756 may be further subdivided into blocks 770, which can contain data corresponding to, for example, 16×16 pixels in the frame 756. The blocks 770 can also be arranged to include data from one or more segments 758 of pixel data. The blocks 770 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

Referring again to FIG. 7A, when the video stream 750 is presented for encoding, respective adjacent frames 754, such as the frame 756, can be processed in units of blocks. At the intra/inter prediction stage 702, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 702 to produce a residual block (also called a residual). The transform stage 704 transforms the residual into transform coefficients in, for example, the frequency domain using block-based transforms. The quantization stage 706 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 708. The entropy-encoded coefficients, together with other information used to decode the block (which may include, for example, syntax elements such as used to indicate the type of prediction used, transform type, motion vectors, a quantizer value, or the like), are then output to the compressed bitstream 720. The compressed bitstream 720 can be formatted using various techniques, such as variable length coding (VLC) or arithmetic coding. The compressed bitstream 720 can also be referred to as an encoded video stream or encoded video bitstream, and the terms will be used interchangeably herein.

The reconstruction path (shown by the dotted connection lines) can be used to ensure that the encoder 700 and a decoder 800 (described below with respect to FIG. 8) use the same reference frames to decode the compressed bitstream 720. The reconstruction path performs functions that are similar to functions that take place during the decoding process (described below with respect to FIG. 8), including dequantizing the quantized transform coefficients at the dequantization stage 710 and inverse transforming the dequantized transform coefficients at the inverse transform stage 712 to produce a derivative residual block (also called a derivative residual). At the reconstruction stage 714, the prediction block that was predicted at the intra/inter prediction stage 702 can be added to the derivative residual to create a reconstructed block. The loop filtering stage 716 can be applied to the reconstructed block to reduce distortion such as blocking artifacts.

Other variations of the encoder 700 can be used to encode the compressed bitstream 720. In some implementations, a non-transform based encoder can quantize the residual signal directly without the transform stage 704 for certain blocks or frames. In some implementations, an encoder can have the quantization stage 706 and the dequantization stage 710 combined in a common stage.

FIG. 8 is a block diagram of a decoder 800. The decoder 800 can be implemented in a receiving device, which may be as described with respect to the computing device 200 of FIG. 2, by providing a computer software program stored in the memory 204. The computer software program can include machine instructions that, when executed by a processor such as the processor 202, cause the receiving device to decode video data in the manner described in FIG. 8.

The decoder 800, similar to the reconstruction path of the encoder 700 discussed above, includes in one example the following stages to perform various functions to produce an output video stream 816 from the compressed bitstream 720: an entropy decoding stage 802, a dequantization stage 804, an inverse transform stage 806, an intra/inter prediction stage 808, a reconstruction stage 810, a loop filtering stage 812, and a deblocking filtering stage 814. Other structural variations of the decoder 800 can be used to decode the compressed bitstream 720.

When the compressed bitstream 720 is presented for decoding, the data elements within the compressed bitstream 720 can be decoded by the entropy decoding stage 802 to produce a set of quantized transform coefficients. The dequantization stage 804 dequantizes the quantized transform coefficients (e.g., by multiplying the quantized transform coefficients by the quantizer value), and the inverse transform stage 806 inverse transforms the dequantized transform coefficients to produce a derivative residual that can be identical to that created by the inverse transform stage 712 in the encoder 700. Using header information decoded from the compressed bitstream 720, the decoder 800 can use the intra/inter prediction stage 808 to create the same prediction block as was created in the encoder 700 (e.g., at the intra/inter prediction stage 702).

At the reconstruction stage 810, the prediction block can be added to the derivative residual to create a reconstructed block. The loop filtering stage 812 can be applied to the reconstructed block to reduce blocking artifacts. Other filtering can be applied to the reconstructed block. In this example, the deblocking filtering stage 814 is applied to the reconstructed block to reduce blocking distortion, and the result is output as the output video stream 816. The output video stream 816 can also be referred to as a decoded video stream, and the terms will be used interchangeably herein. Other variations of the decoder 800 can be used to decode the compressed bitstream 720. In some implementations, the decoder 800 can produce the output video stream 816 without the deblocking filtering stage 814.

To further describe some implementations in greater detail, reference is next made to examples of techniques which may be performed by or using a system for obtaining a probability that a video frame has low quality.

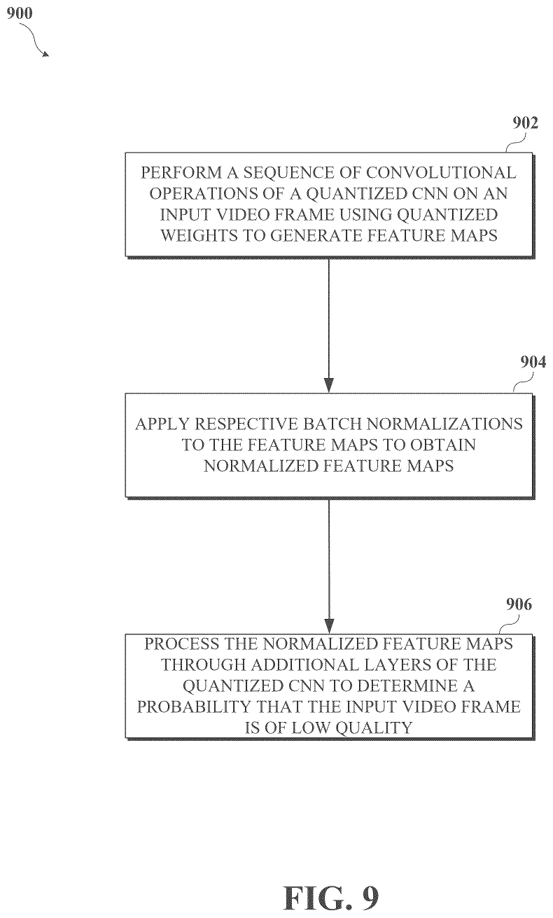

FIG. 9 is a flowchart of a technique 900 for determining the probability of a video frame being of low quality. The technique 900 can be implemented, for example, by a CNN that may be executed by computing devices such as the computing device of FIG. 2. The CNN may be implemented as using specialized hardware or firmware. The CNN can be the quantized CNN described above. The technique 900 can be executed using computing devices, such as the systems, hardware, and software described with respect to FIGS. 1-8. As such, the quantized CNN may be implemented by a device that, in an example, can be a device that reduces the amount of RAM needed for activation storage. For example, the device can be a data streaming accelerator. A data streaming accelerator is a hardware designed to enhance the speed and efficiency of processing and transmitting real-time data streams, such as video data.

At 902, a sequence of convolutional operations of the quantized CNN are performed on an input video frame using quantized weights to generate feature maps. The input video frame can include only a luminance data (e.g., a luminance plane). The quantized weights can be obtained by simulating quantization during a training phase that uses floating-point weights, as described above. As described above, the quantized CNN can be trained using a loss function that is based on a correlation between determined probabilities and human subjective quality ratings of a batch of videos of size n. The loss function can be based on a negative squared Pearson linear correlation coefficient.

The convolutional operations can include a first convolutional layer and a second convolutional layer, where the first convolutional layer is configured to apply a plurality of 1×N kernels to analyze horizontal dimensions of an input to the first convolutional layer, and where the second convolutional layer is configured to apply a plurality of N×1 kernels to analyze vertical dimensions of an input to the second convolutional layer.

At 904, respective batch normalizations are applied to the feature maps to obtain normalized feature maps. Applying a batch normalization to a feature map of the feature maps includes applying a linear function to the feature map. The linear function can be as described with respect to equation (5). As such, the linear function includes multiplying each feature of the feature map by a learned scaling factor. The batch normalization operation can be fused with a respective convolutional operation, as described above. The batch normalization is performed using only fixed-point arithmetic.

At 906, and after applying the respective batch normalizations, at least some of the normalized feature maps are processed through additional layers of the quantized CNN to determine a probability that the input video frame is of low quality. The additional layers of the quantized CNN can include at least one depth-wise separable convolutional layer. The probability that the input video frame is of low quality can be determined by comparing an output of a layer of the quantized CNN to a predefined threshold and not calculating a sigmoid function for the determination.

The technique 900 may include selecting encoding parameters for a video segment that includes the input video frame based on the probability that the input video frame is of low quality. Selecting the encoding parameters for the video segment can be based on an average of respective probabilities of input video frames that include the input video frame.

The technique 900 may include applying a respective quantized activation function after each convolutional operation of at least some of the convolutional operations.

The structure of the quantized CNN can be or include a first convolutional layer, a second convolutional layer subsequent to and coupled to the first convolutional layer, a third convolutional layer subsequent to and coupled to the second convolutional layer, a fourth max pooling layer subsequent to and coupled to the third convolutional layer, a fifth convolutional layer subsequent to and coupled to the fourth max pooling layer, a sixth global average pooling layer subsequent to and coupled to the fifth convolutional layer, and a seventh dense layer subsequent to and coupled to the sixth global average pooling layer.

For simplicity of explanation, the technique 900 of FIGS. 9, is depicted and described as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such.

Implementations of a quantized CNN can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described embodiments, implementations, and aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method, comprising:
performing a sequence of convolutional operations of a quantized convolutional neural network (quantized CNN) on an input video frame using quantized weights to generate feature maps;
applying respective batch normalizations to the feature maps to obtain normalized feature maps, wherein applying a batch normalization to a feature map of the feature maps comprises applying a linear function to the feature map, wherein the linear function includes multiplying each feature of the feature map by a learned scaling factor; and
after applying the respective batch normalizations, processing the normalized feature maps through additional layers of the quantized CNN to determine a probability that the input video frame is of low quality.

2. The method of claim 1, comprising:
selecting encoding parameters for a video segment that includes the input video frame based on the probability that the input video frame is of low quality.

3. The method of claim 2, wherein selecting the encoding parameters for the video segment based on the probability that the input video frame is of low quality comprises:
selecting the encoding parameters for the video segment based on an average of respective probabilities of input video frames that include the input video frame.

4. The method of claim 1, wherein the quantized weights are obtained by simulating quantization during a training phase that uses floating-point weights.

5. The method of claim 1, wherein the batch normalization is fused with a respective convolutional operation.

6. The method of claim 5, wherein the batch normalization is performed using fixed-point arithmetic.

7. The method of claim 1, comprising:
applying a respective quantized activation function after each convolutional operation of at least some of the convolutional operations.

8. The method of claim 1, wherein the additional layers of the quantized CNN include at least one depth-wise separable convolutional layer.

9. The method of claim 1, wherein the input video frame consists of a luminance plane.

10. The method of claim 1, wherein the quantized CNN is trained using a loss function that is based on a correlation between determined probabilities and human subjective quality ratings of a batch of videos of size n.

11. The method of claim 10, wherein the loss function is based on a negative squared Pearson linear correlation coefficient.

12. The method of claim 1, wherein the convolutional operations comprise a first convolutional layer and a second convolutional layer, wherein the first convolutional layer is configured to apply a plurality of 1×N kernels to analyze horizontal dimensions of an input to the first convolutional layer, and wherein the second convolutional layer is configured to apply a plurality of N×1 kernels to analyze vertical dimensions of an input to the second convolutional layer.

13. The method of claim 1, wherein processing the normalized feature maps through the additional layers of the quantized CNN to determine the probability that the input video frame is of low quality comprises:
determining the probability that the input video frame is of low quality by comparing an output of a layer of the quantized CNN to a predefined threshold and not calculating a sigmoid function for the determination.

14. A device, comprising:
a quantized convolutional neural network (quantized CNN) configured to:
perform a sequence of convolutional operations on an input video frame using quantized weights to generate feature maps;
apply respective batch normalizations to the feature maps to obtain normalized feature maps, wherein to apply a batch normalization to a feature map of the feature maps comprises to apply a linear function to the feature map, wherein the linear function includes multiplying each feature of the feature map by a learned scaling factor; and
after applying the respective batch normalizations, process the normalized feature maps through additional layers of the quantized CNN to determine a probability that the input video frame is of low quality.

15. The device of claim 14, wherein the quantized CNN is configured to:
select encoding parameters for a video segment that includes the input video frame based on the probability that the input video frame is of low quality.

16. The device of claim 14, wherein the batch normalization is fused with a respective convolutional operation.

17. The device of claim 16, wherein the batch normalization is performed using fixed-point arithmetic.

18. The device of claim 14, wherein the quantized CNN is trained using a loss function that is based on a correlation between determined probabilities and human subjective quality ratings of a batch of videos of size n and wherein the loss function is based on a negative squared Pearson linear correlation coefficient.

19. The device of claim 14, wherein the convolutional operations comprise a first convolutional layer and a second convolutional layer, wherein the first convolutional layer is configured to apply a plurality of 1×N kernels to analyze horizontal dimensions of an input to the first convolutional layer, and wherein the second convolutional layer is configured to apply a plurality of N×1 kernels to analyze vertical dimensions of an input to the second convolutional layer.

20. A device, comprising:
a quantized convolutional neural network (quantized CNN), comprising:
layers consisting of:
a first convolutional layer;
a second convolutional layer subsequent to and coupled to the first convolutional layer;
a third convolutional layer subsequent to and coupled to the second convolutional layer;
a fourth max pooling layer subsequent to and coupled to the third convolutional layer;
a fifth convolutional layer subsequent to and coupled to the fourth max pooling layer;
a sixth global average pooling layer subsequent to and coupled to the fifth convolutional layer; and
a seventh dense layer subsequent to and coupled to the sixth global average pooling layer,
wherein the seventh dense layer simulates a sigmoid function by comparing an output of a fully connected layer to a constant learned during a training phase,
wherein at least one of the first convolutional layer, the second convolutional layer, the third convolutional layer, or the fifth convolutional layer is configured to apply a batch normalization to an input feature map by applying a linear function to the input feature map, wherein the linear function includes multiplying each feature of the input feature map by a learned scaling factor,
wherein none of the layers are configured to perform floating point operations, and
wherein weights of the quantized CNN are fixed point weights learned during a training process that uses simulated and heterogeneous quantization.
